(19) United States
(12) Patent Application Publication
(10) Pub. No.: US 2022/0281508 A1
(43) Pub. Date: Sep. 8, 2022

(54) TRAY SYSTEM

(71) Applicant: RAM GANGISETTY, San Jose, CA (US)

(72) Inventor: RAM GANGISETTY, San Jose, CA (US)

(21) Appl. No.: 17/192,775

(22) Filed: Mar. 4, 2021

(51) Int. Cl. B62D 1/04; B60R 7/06

(52) U.S. Cl. CPC B62D 1/046; B60R 7/06; B60R 2011/0059

(57) ABSTRACT

A tray system and method can include: a tray body including a centerline, the tray body configurable to flip about the centerline, the tray body having a first tray side and a second tray side, the second tray side opposite the first tray side; and a receiving arm extended from the tray body and extended toward the centerline, the receiving arm configured to receive a steering wheel between the receiving arm and the tray body.

### TECHNICAL FIELD

This disclosure relates to tray systems, more particularly to tray systems employing receiving arms for receiving a steering wheel.

### BACKGROUND

Vehicles have long provided the secondary function as a place to spend time engaging in activities such as eating, reading, or working. In this capacity, vehicles have provided a sub-optimal solution for these secondary functions due to the placement of the steering wheel and other control surfaces required to operate the vehicle.

Many previous developments have attempted to provide a more useable solution to eating, reading, and working inside a vehicle. However, these previous developments have provided only partial solutions.

Any full solution should provide hands free operation, stability, universal fit, windows up operation, and allow a user to adjust their position without jostling the work surface. One previous development is a window tray that can be attached to a window.

Window trays do allow a tray to be out of the way of a user, and allow hands free operation with the ability to move around. However, window trays must be operated with the window at least partially down which means there is a reduction in the weather barrier provided by the window.

Window trays are also positioned off to the side of a user making them less than ideal for reading or eating over. Another previous development is a lap tray. Sometimes a lap tray will be padded for extra height, and other times it can merely be a lipped tray.

Lap trays are not ideal for vehicles as the control surfaces like the steering wheel, gear shift, seat belts, and parking brakes can unseat the tray from the lap of the user. Furthermore, as the lap trays are generally not secured, the lap tray can tip, slide, or fall easily.

Solutions have been long sought but prior developments have not taught or suggested any complete solutions, and solutions to these problems have long eluded those skilled in the art. Thus there remains a considerable need for devices and methods that can provide a stable, hands free surface, without impinging on the control surfaces of a vehicle, while providing a universal fit, and operational with the windows in any position.

### SUMMARY

A tray system and methods, providing a stable, hands free surface, without being negatively impacted by control surfaces of a vehicle, while providing a universal fit, and operational with the windows in any position, are disclosed. The tray system and methods can include: a tray body including a centerline, the tray body configurable to flip about the centerline, the tray body having a first tray side and a second tray side, the second tray side opposite the first tray side; and a receiving arm extended from the tray body and extended toward the centerline, the receiving arm configured to receive a steering wheel between the receiving arm and the tray body.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The tray system is illustrated in the figures of the accompanying drawings which are meant to be exemplary and not limiting, in which like reference numerals are intended to refer to like components, and in which:

FIG. 1 is an isometric view of a grooved tray side of the tray system.

FIG. 2 is an isometric view of a recessed tray side of the tray system.

FIG. 3 is an isometric view of the tray system of FIG. 1 in a mounted phase of operation.

FIG. 4 is an isometric view of the tray system of FIG. 2 in a pre-attachment phase of operation.

FIG. 5 is an enlarged isometric view of the area A FIG. 4.

FIG. 6 is a side view of the outward facing side of the grip pad of FIG. 1.

FIG. 7 is a side view of the terminal end of the grip pad of FIG. 1.

FIG. 8 is an isometric view of the grip pads in various different sizes.

FIG. 9 is an isometric view of the recessed tray side of FIG. 2 in an attachment phase of operation.

FIG. 10 is a flow chart for manufacturing the tray system.

### DETAILED DESCRIPTION

In the following description, reference is made to the accompanying drawings that form a part hereof, and in which are shown by way of illustration, embodiments in which the tray system may be practiced. It is to be understood that other embodiments may be utilized and structural changes may be made without departing from the scope of the tray system.

When features, aspects, or embodiments of the tray system are described in terms of steps of a process, an operation, a control flow, or a flow chart, it is to be understood that the steps can be combined, performed in a different order, deleted, or include additional steps without departing from the tray system as described herein.

The tray system is described in sufficient detail to enable those skilled in the art to make and use the tray system and provide numerous specific details to give a thorough understanding of the tray system; however, it will be apparent that the tray system may be practiced without these specific details.

In order to avoid obscuring the tray system, some well-known system configurations and descriptions are not disclosed in detail. Likewise, the drawings showing embodiments of the system are semi-diagrammatic and not to scale and, particularly, some of the dimensions are for the clarity of presentation and are shown greatly exaggerated in the drawing FIGs. As used herein, the term couple as in coupled or coupling is defined as direct or indirect physical contact between elements.

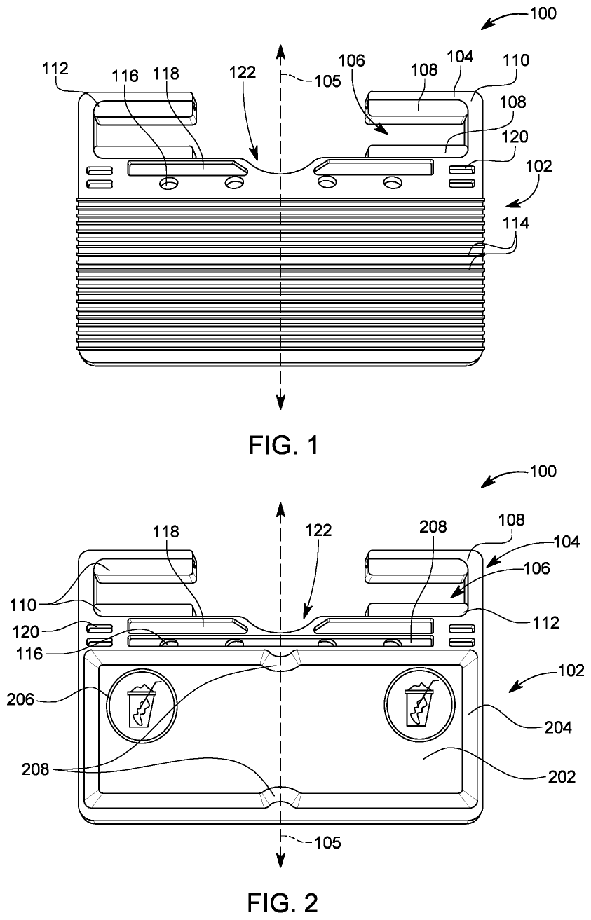

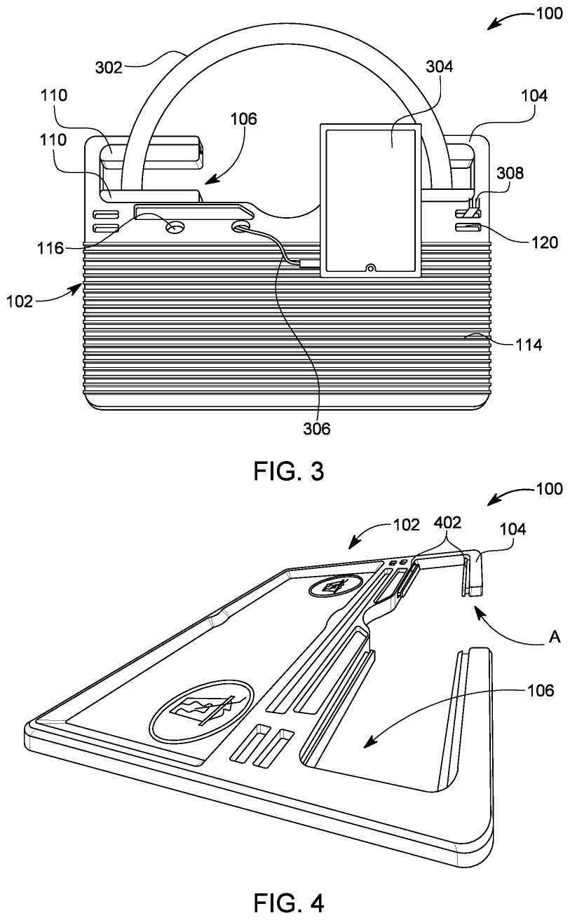

Referring now to FIG. 1, therein is shown an isometric view of a grooved tray side of the tray system 100. The tray system 100 is depicted having a tray body 102 and receiving arms 104. The receiving arms 104 being on a side of the tray system 100 intended to be placed around, and to receive, the steering wheel 302 of FIG. 3, for example.

The tray system 100 can be flipped about a centerline 105 in order to maintain the receiving arms 104 positioned toward the steering wheel 302. The tray system 100 can be flipped about the centerline 105 to place the grooved tray side up or down, while the recessed tray side of FIG. 2 will be on an opposite facing side of the tray system 100 than the grooved tray side.

In the present example, the tray system 100 has been flipped about the centerline 105 to place the grooved tray side up and the recessed tray side down. As depicted, the centerline 105 can bisect the tray body 102 and can extend between the receiving arms 104.

The receiving arms 104 can extend from one side of the tray body 102 and then can curve, angle, or bend in toward each other and the centerline 105 to form a mounting cavity 106 between the receiving arms 104 and the tray body 102. The receiving arms 104 can have corners 108 which are depicted as right angles, bending the receiving arms 104 toward each another.

The receiving arms 104 are also shown extending from a single side of the tray body 102 having outer edges that are co-planar with outer edges of the tray body 102. The tray body 102 and the receiving arms 104 can be formed integrally out of a single piece of material for lower cost production.

One such method of forming as a single piece can be through injection molding during which all elements of the tray system 100 can be formed with one single piece of material. The tray system 100 can have characteristics of being formed by injection molding including seams created by an injection mold and surface irregularities created by injection ports.

As such the tray system 100 is contemplated to be formed of plastic. However, other materials are contemplated as well including metal and wood, or the combination of plastic together with metal and wood.

The tray system 100 is shown having grip pads 110 for coupling and securing the tray system 100 to the steering wheel 302. The grip pads 110 can be a rubber, plastic, or silicone. The grip pads 110 can be formed from other materials such as wood or metal without deviating from the tray system 100; however, the preferred embodiment should be slightly conformable to the steering wheel 302 for maximum grip.

The grip pads 110 can be mounted to the receiving arms 104 and to the tray body 102 opposite the grip pads 110 on the receiving arms 104. The grip pads 110 are removable and interchangeable.

The grip pads 110 can further be provided in different sizes for adjustability, and to ensure a universal fit to steering wheels of different thicknesses. The grip pads 110 can extend from the receiving arms 104 and the tray body 102 into the mounting cavity 106, making the mounting cavity 106 smaller.

Thus, larger size grip pads 110 will reduce the size of the mounting cavity 106 to fit thinner steering wheels while smaller size grip pads 110 will increase the size of the mounting cavity 106 to fit thicker steering wheels. The grip pads 110 can have a substantially rectangular cross-section with a portion of the cross-section having a radius 112 that mirrors a radius of the corner between the receiving arms 104 and the tray body 102 or mirrors a radius of the corners 108 in the receiving arms 104.

The tray body 102 is depicted as a device holding side of the tray system 100. The device holding side of the tray system 100 can include grooves 114 extending across the tray body 102. The grooves 114 can extend across the tray body 102 in a direction parallel with the grip pads 110.

The grooves 114 allow electronic devices, books, or other materials to be positioned at many viewing angles. Illustratively, the grooves closer to the receiving arms 104 can be used to provide a more vertical orientation to a device held therein, while the grooves 114 further from the receiving arms 104 can be used to provide a more horizontal lean to a device held therein.

The grooves 114 provide a rest for the devices so that they do not slip or move while in use. As the device side of the tray system 100 is contemplated to be used with laptops, tablets, and phones, the tray system 100 is provided with cable through holes 116 for cable management.

The cable through holes 116 can be rounded or oval and can be used to plug a device into a vehicle charge port while the device remains sitting on the grooves 114 so that the cables do not have to be draped over the side of the tray body 102. Rather, any cables connected to a device on the tray body 102 can be neatly run through the cable through holes 116.

It has been discovered that the cable through holes 116 provide cable management allowing the tray system 100 to be used with less mess and simultaneously provides an additional anchor for the device to the tray system 100.

The tray body 102 can also include miscellaneous recesses 118 between the cable through holes 116 and the grip pads 110 mounted to the tray body 102. The miscellaneous recesses 118 can be used to hold many items such as coins, keys, pens or pencils, paper clips, usb sticks, chapstick, makeup, or even trash while in use.

The miscellaneous recesses 118 can be recessed into the tray body 102 without extending therethrough. The tray body 102 can further include utensil through holes 120 between the grooves 114 and the grip pads 110 mounted to the tray body 102.

The utensil through holes 120 can be rectangular for holding utensils such as forks, spoons, and knives. It is contemplated that the tray system 100 could come with a custom fitted utensil set specifically for use with the utensil through holes 120.

Between the miscellaneous recesses 118 and along the centerline 105, the tray body 102 can include an inward bend 122 where the mounting cavity 106 is extended past the grip pads 110 mounted to the tray body 102. It has been discovered that the inward bend 122 can allow the tray system 100 to accommodate a wide range of steering wheels by providing additional room for surface contours of various steering wheel types.

Referring now to FIG. 2, therein is shown an isometric view of a recessed tray side of the tray system 100. The recessed tray side of the tray system 100 can be the side opposite the grooved tray side and can be accessed by flipping the tray system 100 over.

In the present example, the tray system 100 has been flipped about the centerline 105 to place the grooved tray side of FIG. 1 down and the recessed tray side up. The tray system 100 can be flipped about the centerline 105 in order to maintain the receiving arms 104 positioned toward the steering wheel 302 of FIG. 3.

Similar to the grooved tray side, the recessed tray side of the tray system 100 is depicted having the tray body 102 and the receiving arms 104. The receiving arms 104 being on a side of the tray system 100 intended to be placed around, and to receive, the steering wheel 302, for example. As depicted, the centerline 105 can bisect the tray body 102 and can extend between the receiving arms 104.

The receiving arms 104 can extend from one side of the tray body 102 and then can curve, angle, or bend in toward each other to form the mounting cavity 106 between the receiving arms 104 and the tray body 102. The receiving arms 104 are shown having the corners 108 which are depicted as right angles, bending the receiving arms 104 toward each another.

The receiving arms 104 are also shown extending from a single side of the tray body 102 having outer edges that are co-planar with outer edges of the tray body 102. The tray body 102 and the receiving arms 104 can be formed integrally out of a single piece of material for lower cost production.

The tray system 100 is shown having the grip pads 110 for coupling and securing the tray system 100 to the steering wheel 302. The grip pads 110 can be a rubber, plastic, or silicone. The grip pads 110 can be slightly conformable to the steering wheel 302 for maximum grip.

The grip pads 110 can be mounted to the receiving arms 104 and to the tray body 102 opposite the grip pads 110 on the receiving arms 104. The grip pads 110 are removable and interchangeable.

The grip pads 110 can have a substantially rectangular cross-section with a portion of the cross-section having the radius 112 that mirrors a radius of the corner between the receiving arms 104 and the tray body 102 or mirrors a radius of the corners 108 in the receiving arms 104.

The tray body 102 is depicted as a recessed tray side of the tray system 100. The recessed tray side of the tray system 100 can include a bottom surface 202 between tray sidewalls 204. The tray sidewalls 204 can extend up from the bottom surface 202 to create a recess for storing food and drinks and to prevent any spillage from running over the side of the tray body 102.

Rather, any food or drink that is unseated from its container will be contained on the bottom surface 202 and between the tray sidewalls 204 for easy cleanup. The bottom surface 202 is contemplated to be substantially flat between the tray sidewalls 204.

However, the bottom surface 202 is contemplated and is shown to have raised protrusions 206 extending out and away from the bottom surface 202. The raised protrusions 206 can function as cup or container holders.

For example, the raised protrusions 206 can extend up from the bottom surface 202 to provide a secure place to set a drink and provide additional lateral support to ensure the cup does not fall over or slide. The bottom surface 202 is contemplated to be substantially flat with none of the grooves 114 of FIG. 1, for example.

The tray sidewalls 204 are shown to include area dividers 208 extended into the bottom surface 202 along the centerline 105. The area dividers 208 can be guides to the placement of food containers and can function to hold food containers on one side of the tray body 102 or the other and to prevent food containers from slipping.

The cable through holes 116 can be seen from the recessed tray side as extending through the tray body 102. The cable through holes 116 can be formed at the bottom of a cable through hole recess 208.

The cable through hole recess 208 can be a recess exposing the cable through holes 116 and providing an additional storage spot for items such as straws or chopsticks when the cable through holes 116 are not in use. The tray body 102 can also include the miscellaneous recesses 118 between the cable through holes 116 and the grip pads 110 mounted to the tray body 102. The miscellaneous recesses 118 can be used to hold many items such as coins, keys, pens or pencils, paper clips, usb sticks, chapstick, makeup, or even trash while in use.

The miscellaneous recesses 118 can be recessed into the tray body 102 without extending therethrough. The tray body 102 can further include the utensil through holes 120 between the bottom surface 202 and the grip pads 110 mounted to the tray body 102.

The utensil through holes 120 can be rectangular for holding utensils such as forks, spoons, and knives. It is contemplated that the tray system 100 could come with a custom fitted utensil set specifically for use with the utensil through holes 120.

Between the miscellaneous recesses 118 and along the centerline 105, the tray body 102 can include an inward bend 122 where the mounting cavity 106 is extended past the grip pads 110 mounted to the tray body 102. It has been discovered that the inward bend 122 can allow the tray system 100 to accommodate a wide range of steering wheels by providing additional room for surface contours of various steering wheel types.

Referring now to FIG. 3, therein is shown an isometric view of the tray system 100 of FIG. 1 in a mounted phase of operation. The tray system 100 is shown with the grooved tray side in use and while mounted to a steering wheel 302.

The tray system 100 is mounted to the steering wheel 302 by placing the grip pads 110 to directly contact both a front and a back of the steering wheel 302. That is, the grip pads 110 mounted on the tray body 102 are in direct contact with a front side of the steering wheel 302 and the grip pads 110 mounted to the receiving arms 104 are in direct contact with the back side of the steering wheel 302.

Therefore, the steering wheel 302 can be within the mounting cavity 106 between the grip pads 110 when the tray system 100 is mounted to the steering wheel 302. As will be appreciated, larger grip pads 110 will decrease the mounting cavity 106 for thinner steering wheels 302 while smaller grip pads 110 will increase the mounting cavity 106 for thicker steering wheels 302.

The tray system 100 is further depicted having a device 304 positioned within the grooves 114 and leaning on the steering wheel 302. The grooves 114 closer to the steering wheel 302 will position the device 304 in a more upright position while the grooves 114 further from the steering wheel 302 will position the device 304 in a more reclined position.

Regardless of position, it has been discovered that the grooves 114 can position the device 304 at a desired angle and can prevent the device 304 from slipping, all the while providing a stable, hands free solution. The device 304 is shown plugged in with a cable 306 extended from the device 304 through one of the through holes 116.

As will be appreciated, the through holes 116 can further restrict movement of the device 304 while maintaining a clean work surface. The tray system 100 is further shown with a utensil 308 within one of the utensil through holes 120.

As will be appreciated, the utensil through holes 120 and the cable through holes 116 ensure that the grooves 114 and work surface remain uncluttered. The utensil through holes 120 hold the utensil 308 in a vertical position away from the device 304 and away from the grooves 114, for example. The cable through holes 116 also hold the cable 306 away from the grooves 114 and work surface.

Referring now to FIG. 4, therein is shown an isometric view of the tray system 100 of FIG. 2 in a pre-attachment phase of operation. In the pre-attachment phase of operation, the receiving arms 104 and the tray body 102 are shown having mounting rails 402 formed thereon.

The mounting rails 402 on the receiving arms 104 and the mounting rails 402 on the tray body 102 can extend toward each other and into the mounting cavity 106. As will be appreciated, the mounting rails 402 can provide an easy, fast, and secure mount for the grip pads 110 of FIG. 1 to extend from the receiving arms 104 and the tray body 102 into the mounting cavity 106 in order to grip the steering wheel 302 of FIG. 3.

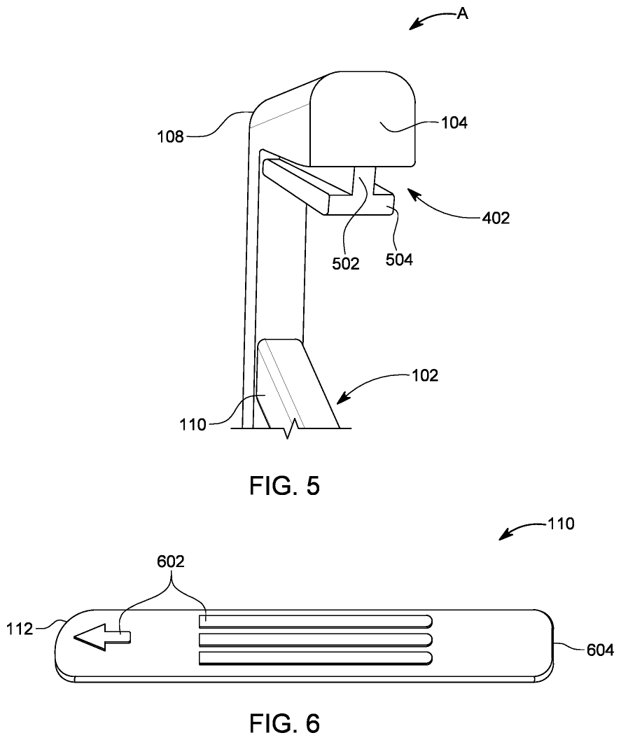

The mounting rails 402 can extend laterally, as discussed in greater detail in FIG. 5 below, however, the mounting rails 402 do not extend past sides of the receiving arms 104 or the tray body 102 to ensure that the grip pads 110 mount flush with the receiving arms 104 and the tray body 102 as is shown in FIGS. 1 and 2, for example.

Referring now to FIG. 5, therein is shown an enlarged isometric view of the area A FIG. 4. The receiving arm 104 is shown in greater detail with the mounting rail 402 extending down from the receiving arm 104 toward the tray body 102.

The mounting rail 402 is shown as a T shaped rail with a center rail portion 502 and a lateral rail portion 504 extending laterally from the center rail portion 502. The center rail portion 502 can extend from the receiving arm 104 in a direction parallel with the centerline 105 of FIG. 1.

The lateral rail portion 504 extends laterally but does not extend beyond edges of the receiving arm 104 but is narrower than the receiving arm 104 in order that the grip pads 110 can be mounted to the mounting rails 402 while being flush with the receiving arms 104. The grip pad 110 is shown mounted to the mounting rail 402 of the tray body 102 and is shown flush with the tray body 102.

The mounting rail 402, including the lateral rail portion 504, is further shown connected to the receiving arms 104 near the corners 108. Similarly, the mounting rail 402 extending from the tray body 102, including the lateral rail portion 504, is shown in FIG. 4 to be connected to the receiving arm 104 near the position that the receiving arm 104 extends from the tray body 102.

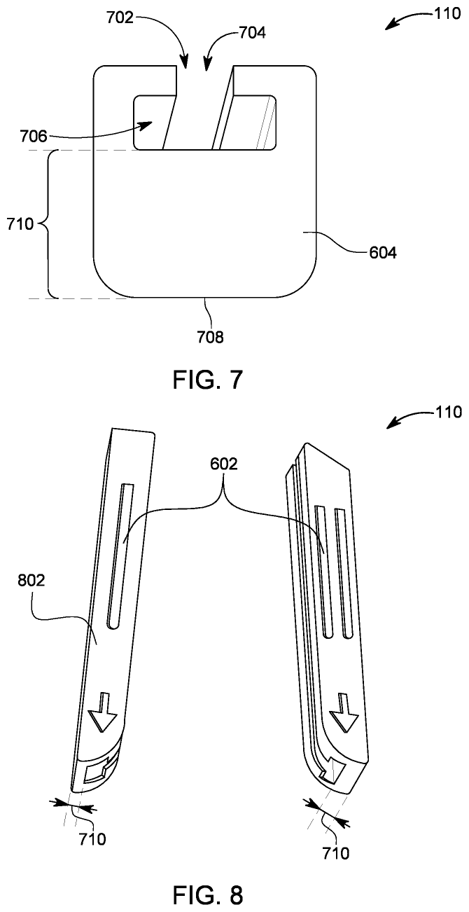

Referring now to FIG. 6, therein is shown a side view of the outward facing side of the grip pad 110 of FIG. 1. The grip pad 110 is shown having surface texture 602 including lateral textures and directional indicator textures. The indicator textures can include an arrow depicting the direction to slide the grip pads 110 for mounting the grip pads 110 onto the receiving arms 104 of FIG. 1 or the tray body 102 also of FIG. 1. The lateral textures can include multiple parallel lines and indicate the thickness 710 of FIG. 7 as thinner with one lateral texture and thicker with two lateral textures as depicted in FIG. 8.

The grip pad 110 is substantially rectangular in cross-section with a portion of the cross-section having the radius 112. The radius 112 can mirror a radius of a corner between the receiving arms 104 and the tray body 102, or the radius 112 can mirror a radius of the corners 108 of FIG. 1 in the receiving arms 104.

The grip pad 110 is further depicted having a terminal end 604. The terminal end 604 can be flush with a terminal end of the receiving arms 104 as is depicted in FIGS. 1 and 2, for example.

As will be appreciated, the grip pad 110 can have sharp, right edges, where the grip pads 110 mount and contact the tray body 102 or the receiving arms 104 to ensure a flush mounting therewith. Furthermore, the terminal end 604 and the edges facing the mounting cavity 106 of FIG. 1 can be rounded to ensure a more comfortable user experience and less wear and tear on the steering wheel 302 of FIG. 3.

Referring now to FIG. 7, therein is shown a side view of the terminal end 604 of the grip pad 110 of FIG. 1. The grip pad 110 includes a mounting receiver 702 that can mate with the mounting rails 402 of FIG. 4.

The mounting receiver 702 can include a center receiver recess 704 which can mate with the center rail portion 502 of FIG. 5. The mounting receiver 702 can further include a lateral receiver recess 706 which can mate with the lateral rail portion 504 of FIG. 5.

As will be appreciated, the mounting receiver 702 will be position on the grip pad 110 near the receiving arm 104 of FIG. 1 or the tray body 102 of FIG. 1, where the mounting rails 402 extend from. The side of the grip pad 110 opposite the mounting receiver 702 can be a mounting cavity side 708.

The mounting cavity side 708 can face the mounting cavity 106 of FIG. 1 and away from the mounting rail 402 coupling the grip pad 110 to the tray system 100 of FIG. 1. The distance between the mounting cavity side 708 and the lateral receiver recess 706 of the mounting receiver 702 can be considered the thickness 710 of the grip pad 110.

The thickness 710 of the grip pad 110 can determine how far the mounting cavity side 708 of the grip pad 110 extends into the mounting cavity 106, and thereby determine how large the mounting cavity 106 will be between the grip pads 110 on the tray body 102 and the grip pads 110 on the receiving arms 104.

That is, when the thickness 710 of the grip pads 110 is larger, the mounting cavity 106 will be smaller for accommodating thinner steering wheels 302 of FIG. 3. Conversely, when the thickness 710 of the grip pads 110 is smaller, the mounting cavity 106 will be larger for accommodating thicker steering wheels 302.

At the extreme, the thickness 710 should be the thickness of the steering wheel 302 subtracted from the distance between the receiving arms 104 and the tray body 102, which would produce a tight fit with the steering wheel 302. However, having the grip pads 110 with a thinner thickness 710 would allow the tray body 102 to be at an angle with respect to the steering wheel 302. In this case the pad can be removed entirely or have a minimal thickness 710 for grip between the receiving arms 104 and the steering wheel 302.

As discussed previously, the grip pad 110 is shown having sharp, right edges, where the grip pads 110 mount and contact the tray body 102 or the receiving arms 104 to ensure a flush mounting therewith. Furthermore, the edges of the grip pads 110 contacting the mounting cavity side 708 can be rounded to ensure a more comfortable user experience and less wear and tear on the steering wheel 302.

Referring now to FIG. 8, therein is shown an isometric view of the grip pads 110 in various different sizes. The grip pads 110 for example can have the thickness 710 varying from small to large in the grip pads 110 shown.

Illustratively, the grip pad 802 on the left, is shown having a small thickness 710, while the grip pad 804 on the right, is shown having a large thickness 710. The grip pads 110 can come in many various thicknesses 710 and can include the surface texture 602 depicted as the lateral texture indicating a thicker or thinner thickness 710, to enable effective use while lighting conditions are poor.

The grip pads 110 therefore can provide a universal fit on any steering wheel 302 of FIG. 3. It has been discovered that the grip pads 110 can be easily removable and interchangeable for fast accommodation for any thickness of steering wheel.

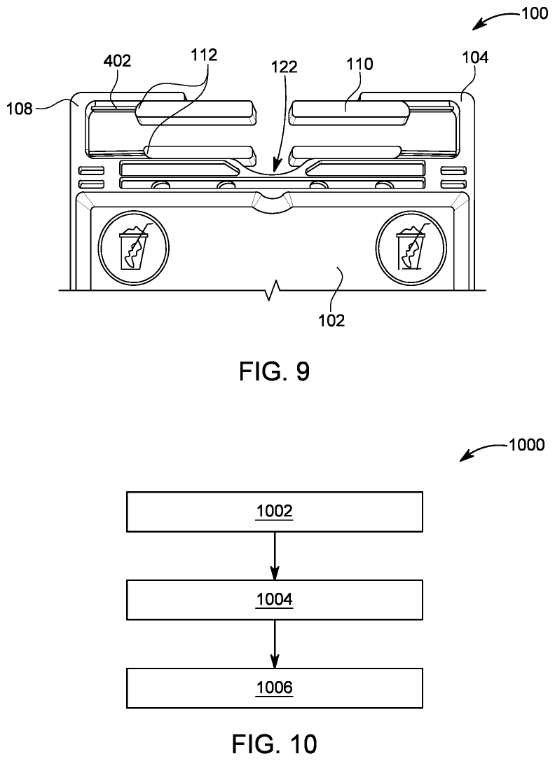

Referring now to FIG. 9, therein is shown an isometric view of the recessed tray side of FIG. 2 in an attachment phase of operation. The tray system 100 is shown having the grip pads 110 partially mounted to the receiving arms 104 and the tray body 102.

As will be appreciated, the mounting receiver 702 of FIG. 7 within the grip pads 110, are being mated with the mounting rails 402. The grip pads 110 can therefore be easily slid onto the mounting rails 402 of the receiving arms 104 and the tray body 102.

Whether the grip pads 110 are mounted to the receiving arms 104 or the tray body 102, the grip pads 110 will stop when fully pushed onto the mounting rails 402, and when the radius 112 of the grip pads 110 make direct contact with the portion of the receiving arms 104 that extend away from the tray body 102 or the corners 108.

Direct contact with the receiving arms 104 can provide a simple yet robust solution to ensure exact fitment of the grip pads 110 during the attachment phase of operation. The inward bend 122 is shown within the tray body 102 and can be used during the mounting process to provide extra room to maneuver the grip pads 110 when attaching them to the mounting rails 402 on the tray body 102.

Referring now to FIG. 10, therein is shown a flow chart for manufacturing 1000 the tray system 100. The flow chart for manufacturing 1000 can include forming a tray body including a centerline, the tray body configurable to flip about the centerline, the tray body having a recessed tray side and a grooved tray side, the grooved tray side opposite the recessed tray side in a block 1002; forming a receiving arm extended from the tray body and extended toward the centerline, the receiving arm configured to receive a steering wheel between the receiving arm and the tray body in a block 1004; and coupling a grip pad to the receiving arm or the tray body and configured to make direct contact the steering wheel in a block 1006.

Thus, it has been discovered that the tray system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the tray system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A tray system comprising:
a tray body including a centerline, the tray body configurable to flip about the centerline, the tray body having a first tray side and a second tray side, the second tray side opposite the first tray side; and
a receiving arm extended from the tray body and extended toward the centerline, the receiving arm configured to receive a steering wheel between the receiving arm and the tray body.

2. The system of claim 1 wherein the tray body includes an area divider formed on the first tray side of the tray body.

3. The system of claim 1 wherein the tray body includes a through hole formed entirely through the tray body from the first tray side to the second tray side.

4. The system of claim 1 wherein the tray body includes tray sidewalls formed on the first tray side of the tray body.

5. The system of claim 1 wherein the tray body includes a groove formed on the second tray side of the tray body, the groove configured to hold an electronic device between the groove and the steering wheel.

6. A tray system comprising:
a tray body including a centerline, the tray body configurable to flip about the centerline, the tray body having a first tray side and a second tray side, the second tray side opposite the first tray side;
a receiving arm extended from the tray body and extended toward the centerline, the receiving arm configured to receive a steering wheel between the receiving arm and the tray body; and
a grip pad coupled to the receiving arm or the tray body, the grip pad configured to make direct contact the steering wheel.

7. The system of claim 6 further comprising a second grip pad having a different thickness than the grip pad.

8. The system of claim 6 wherein:
the tray body or the receiving arm includes a mounting rail; and
the grip pad includes a mounting receiver mated with the mounting rail.

9. The system of claim 6 wherein the grip pad mounts to the receiving arm; and
further comprising a second grip pad mounted to the tray body.

10. The system of claim 6 wherein the tray body includes a utensil through hole.

11. A method of manufacturing a tray system comprising:
forming a tray body including a centerline, the tray body configurable to flip about the centerline, the tray body having a first tray side and a second tray side, the second tray side opposite the first tray side; and
forming a receiving arm extended from the tray body and extended toward the centerline, the receiving arm configured to receive a steering wheel between the receiving arm and the tray body.

12. The method of claim 11 wherein forming the tray body includes forming an area divider on the first tray side of the tray body.

13. The method of claim 11 wherein forming the tray body includes forming a through hole entirely through the tray body from the first tray side to the second tray side.

14. The method of claim 11 wherein forming the tray body includes forming tray sidewalls on the first tray side of the tray body.

15. The method of claim 11 wherein forming the tray body includes forming a groove on the second tray side of the tray body, the groove configured to hold an electronic device between the groove and the steering wheel.

16. The method of claim 11 further comprising coupling a grip pad to the receiving arm or the tray body, the grip pad configured to make direct contact the steering wheel.

17. The method of claim 16 further comprising providing a second grip pad having a different thickness than the grip pad.

18. The method of claim 16 wherein:
forming the tray body or forming the receiving arm includes forming a mounting rail; and
coupling the grip pad includes coupling the grip pad with a mounting receiver mated with the mounting rail.

19. The method of claim 16 wherein coupling the grip pad includes mounting the grip pad to the receiving arm; and
further comprising mounting a second grip pad to the tray body.

20. The method of claim 16 wherein forming the tray body includes forming a utensil through hole.
